(19) United States
(12) Patent Application Publication
(10) Pub. No.: US 2003/0159418 A1
(43) Pub. Date: Aug. 28, 2003

(54) Lawn mower with a connecting frame adapted to be coupled to a vehicle

(76) Inventor: Paul Lin, Yung-Kaug City (TW)

Correspondence Address: BRINKS HOFER GILSON & LIONE, NBC Tower, Suite 3600, 455 N. Cityfront Plaza Drive, Chicago, IL, 60611-5599, US

(21) Appl. No.: 10/074,342

(22) Filed: Feb. 12, 2002

(51) Int. Cl. A01D 75/30

(52) U.S. Cl. 56/14.7; 56/6

(57) ABSTRACT

A lawn mower is provided with a connecting frame of a sufficient length such that the connecting frame can be fastened to a vehicle for synchronous movement therewith so as to mow a lawn when both the vehicle and a cutter unit of the lawn mower are activated.

### BACKGROUND OF THE INVENTION

1. Field of the Invention

The invention relates to a lawn mower, more particularly to a lawn mower with a connecting frame that is adapted to be coupled to a vehicle for moving together therewith.

2. Description of the Related Art

FIG. 1 illustrates a conventional lawn mower which includes a housing 11 defining a bottom opening, a wheel unit 12 mounted rotatably on the housing 11, a cutter unit 142 mounted in the housing 11 and having a cutting edge exposed from the bottom opening, a drive unit 14 for activating the cutter unit 142, and a handle for moving the housing 10 on a ground.

The aforesaid conventional lawn mower is disadvantageous in that it is inefficient in case of a relatively large lawn field area is to be mowed.

### SUMMARY OF THE INVENTION

Therefore, the main object of this invention is to provide a lawn mower with a connecting frame that is adapted to be coupled to a vehicle so as avoid the aforementioned disadvantage which results from the use of the conventional lawn mower.

Accordingly, a lawn mower of the present invention includes a housing having a bottom opening, a wheel unit mounted rotatably on the housing, a cutter unit mounted within the housing and having a cutting edge exposed from the bottom opening, a drive unit mounted on the housing and operably connected to the cutter unit for activating the cutter unit, and a connecting frame adapted to be connected to a vehicle, and having a pivot end connected pivotally to the housing and a connecting end extending therefrom to a length which permits coupling of the connecting end to the vehicle such that the housing can move together with the vehicle when the latter is activated.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective view of a conventional lawn mower;

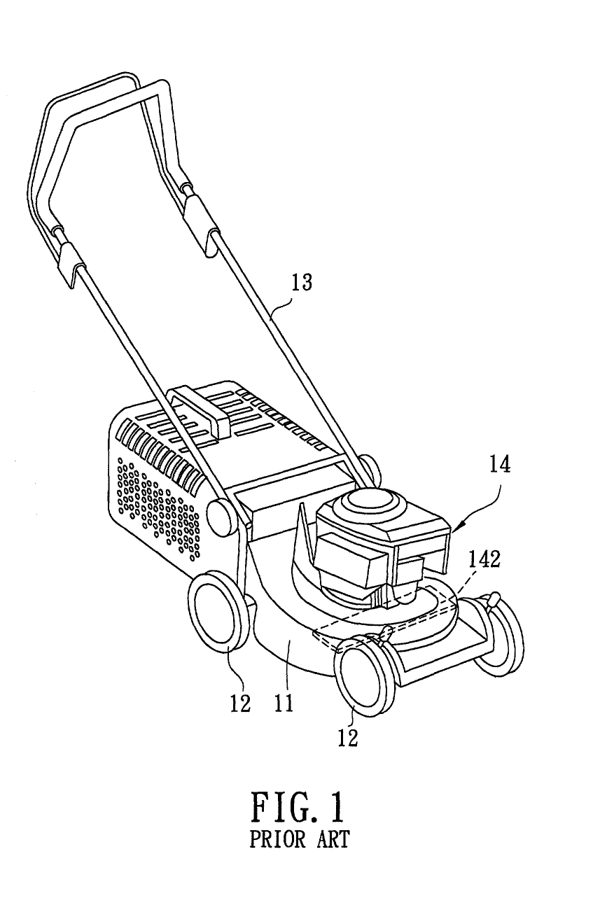

FIG. 2 is a perspective view of a preferred embodiment of a lawn mower of the present invention;

FIG. 3 is a schematic side view of the preferred embodiment; and

FIG. 4 is a top view illustrating how the preferred embodiment can be moved by a vehicle.

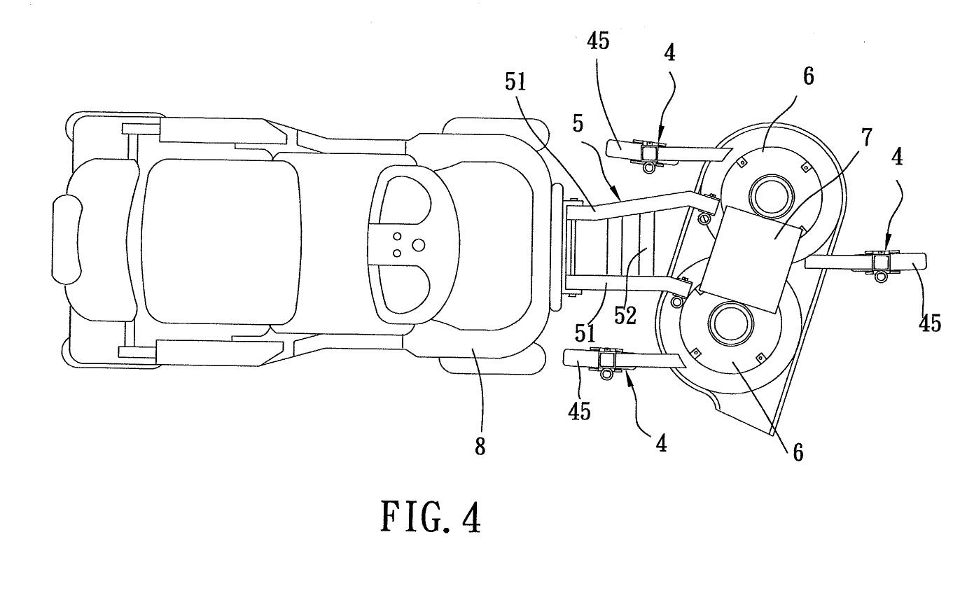

### DETAILED DESCRIPTION OF THE PREFERRED EMBODIMENT

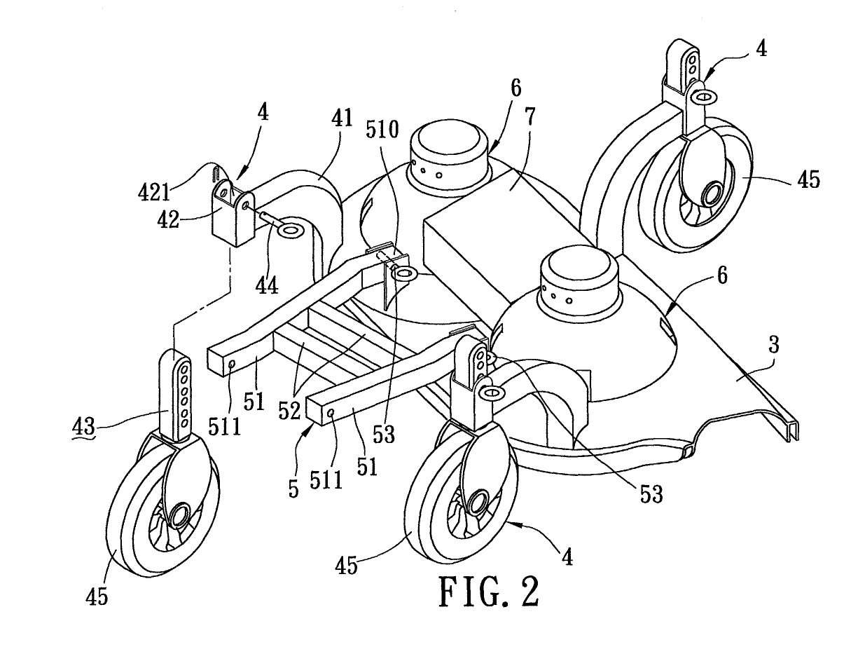

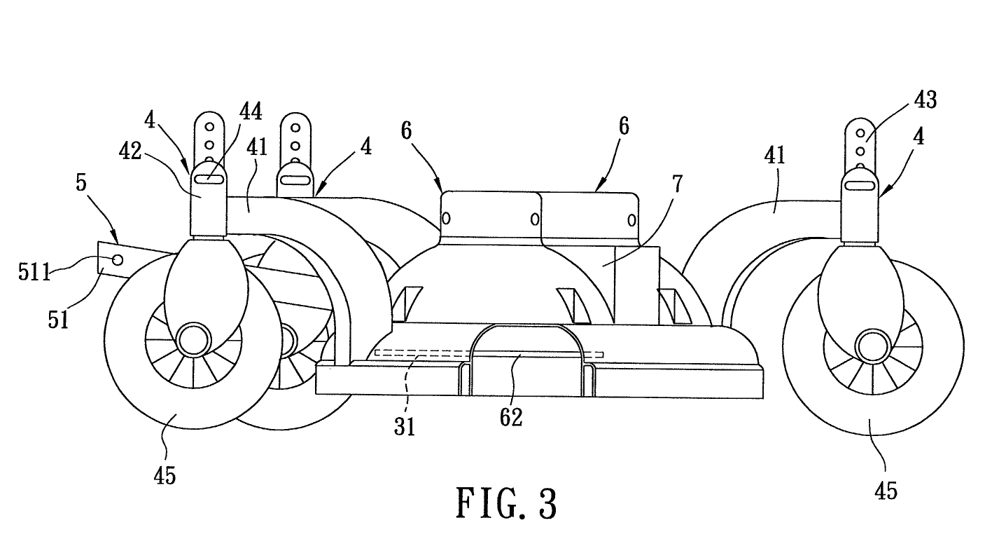

Referring to FIGS. 2 and 3, the preferred embodiment of a lawn mower according to the present invention is shown to include a housing 3, a wheel unit 4, two cutter units 6, a drive unit 7, and a connecting frame 5.

As illustrated, the housing 3 has a bottom opening 31.

The wheel unit 4 is mounted rotatably on the housing 3.

The cutter unit 6 is mounted within the housing 3, and has a cutting edge 62 exposed from the bottom opening 31.

The drive unit 7, preferably a power source, is mounted on the housing 3, and is operably connected to the cutter unit 6 for activating the cutter unit 6. Preferably, the drive unit 7 is interposed between and interconnects two of the cutter units 6 for synchronously operating the same.

The connecting frame 5 is adapted to be connected to a vehicle 8, and includes two generally parallel frame portions 51 that have two pivot ends 510 connected pivotally on the housing 3 via two pivot pins 53, and two connecting ends 511 extending therefrom to a length which permits coupling of the connecting ends 511 to the vehicle 8 such that the housing 3 can move together with the vehicle 8. The connecting frame 5 is rotatable about the pivot pins 53 so as to ensure smooth mowing for the lawn mower and so as to be adjustable to different angles relative to the housing 3 in order to be adapted to be connected to different vehicles 8. Two reinforcing rods 52 are interposed between the frame portions 51 in order to enhance rigidity of the connecting frame 5.

The housing 3 includes a shell portion having top and bottom sides, and three L-shaped wheel-mounting legs 41 that project upwardly from the top side. The wheel unit 4 includes three caster-type rollers 45 mounted adjustably and respectively on the wheel-mounting legs 41 in such a manner that a height of the bottom opening 31 relative to a ground surface can be altered.

In the preferred embodiment, each of the wheel-mounting legs 41 is formed with a bracket 42 that defines a vertical shaft hole 421 therethrough. Each of the caster-type rollers 45 includes a vertical shaft 43 that is formed with a plurality of vertically aligned retaining holes and that is adjustably inserted into the shaft hole 421 of the bracket 42 via a fastener pin 44 releasably extending into a selected one of the retaining holes in order to adjust the height of the bottom opening 31 relative to the ground surface.

Since the connecting frame 5 employed in the preferred embodiment is connectable to the vehicle 8, the efficiency of the lawn mower according to the present invention can be enhanced.

With this invention thus explained, it is apparent that numerous modifications and variations can be made without departing from the scope and spirit of this invention. It is therefore intended that this invention be limited only as indicated in the appended claims.

I claim:

1. A lawn mower comprising:
a housing having a bottom opening;
a wheel unit mounted rotatably on said housing;
a cutter unit mounted within said housing, and having a cutting edge exposed from said bottom opening;
a drive unit mounted on said housing and operably connected to said cutter unit for activating said cutter unit; and
a connecting frame adapted to be connected to a vehicle, and having a pivot end connected pivotally to said housing and a connecting end extending therefrom to a length which permits coupling of said connecting end to the vehicle such that said housing can move together with the vehicle.

2. The lawn mower as defined in claim 1, wherein said housing includes a shell portion having top and bottom sides, and a plurality of wheel-mounting legs projecting upwardly from said top side, said wheel unit including a plurality of caster-type rollers mounted adjustably and respectively on said wheel-mounting legs in such a manner that a height of said bottom opening relative to a ground surface can be altered.

3. The lawn mower as defined in claim 2, wherein each of said wheel-mounting legs is formed with a bracket that defines a vertical shaft hole therethrough, each of said caster-type rollers including a vertical shaft adjustably inserted into said shaft hole in said bracket in order to adjust the height of said bottom opening relative to the ground surface.
